(19) United States
(12) Patent Application Publication
(10) Pub. No.: US 2011/0317436 A1
(43) Pub. Date: Dec. 29, 2011

(54) Outdoor light unit with angle adjustability

(75) Inventor: Hsin-Ning KUAN, Wugu Township (TW)

(73) Assignee: Thermoking Technology International

(21) Appl. No.: 12/822,228

(22) Filed: Jun. 24, 2010

(51) Int. Cl. F21V 29/00; F21V 17/00

(52) U.S. Cl. 362/373; 362/362; 362/375

(57) ABSTRACT

An outdoor light unit with angle adjustability is disclosed. The outdoor light unit of the present invention comprises a casing, a seat potion, a light portion and a cover portion. A hollow space is provided in the casing to hold the seat potion. A hollow space is provided in the seat potion and a through hole is provided on either wall of the seat potion. The light portion may be fitted in the hollow space of the seat potion. A rotation shaft is provided on either side wall of the light portion and either rotation shaft may be aligned with the corresponding through hole of the seat potion. Last, the cover portion may be fitted to the underside of the seat potion to hold the light portion in the outdoor light unit. The outdoor light unit of the present invention is formed with the above components.

### BACKGROUND OF THE INVENTION

1. Field of the invention

The invention generally relates to an outdoor light unit. More particularly, the invention relates to an outdoor light unit whose angle may be adjusted according the actual need.

2. Description of the prior art

When it gets dark in the outdoor, people would turn on their indoor and outdoor lights to light up the environment, enhance safety and to prevent thefts.

However, there are many dark places that can not be lit up in the outdoor environment. In addition, the angle of the light unit of the prior art is fixed and can not be adjusted; therefore, many dark places can not be lit up, the safety of people is endangered and thefts may thus be increased. If another light unit is used, more expense is needed.

From the above, we can see that the light unit of the prior art has many disadvantages and needs to be improved.

To eliminate the disadvantages in the prior art, the inventor has put a lot of effort into the subject and has successfully come up with the outdoor light unit of the present invention.

### SUMMARY OF THE INVENTION

An object of the present invention is to provide an outdoor light unit whose angle may be adjusted according to the actual need.

Another object of the present invention is to provide an outdoor light unit that can be used to provide illumination to darker places to enhance the safety of people and to prevent thefts.

To reach these objects, the outdoor light unit of the present invention is disclosed. The outdoor light unit of the present invention comprises a casing, a seat potion, a light portion and a cover portion. A hollow space is provided in the casing to hold the seat potion. A hollow space is provided in the seat potion and a through hole is provided on either wall of the seat potion. The light portion may be fitted in the hollow space of the seat potion. A rotation shaft is provided on either side wall of the light portion and either rotation shaft may be aligned and engage with the corresponding through hole of the seat potion. Therefore, the angle of the light portion may be adjusted. Last, the cover portion may be fitted to the underside of the seat potion to hold the light portion in the outdoor light unit. The outdoor light unit of the present invention is formed with the above components. Therefore, a user can adjust the angle of the outdoor light unit.

These features and advantages of the present invention will be fully understood and appreciated from the following detailed description of the accompanying Drawings.

### BRIEF DESCRIPTION OF THE DRAWINGS

FIG. 1A is an exploded view of the outdoor light unit of the present invention.

FIG. 1B is a partially exploded view of the outdoor light unit of the present invention.

FIG. 1C is a perspective view of the outdoor light unit of the present invention in an assembled condition.

FIG. 2 is a sectional view of the outdoor light unit of the present invention.

FIGS. 3A, 3B and 3C illustrate how the outdoor light unit of the present invention is put together and used.

### DETAILED DESCRIPTION OF THE PREFERRED EMBODIMENT

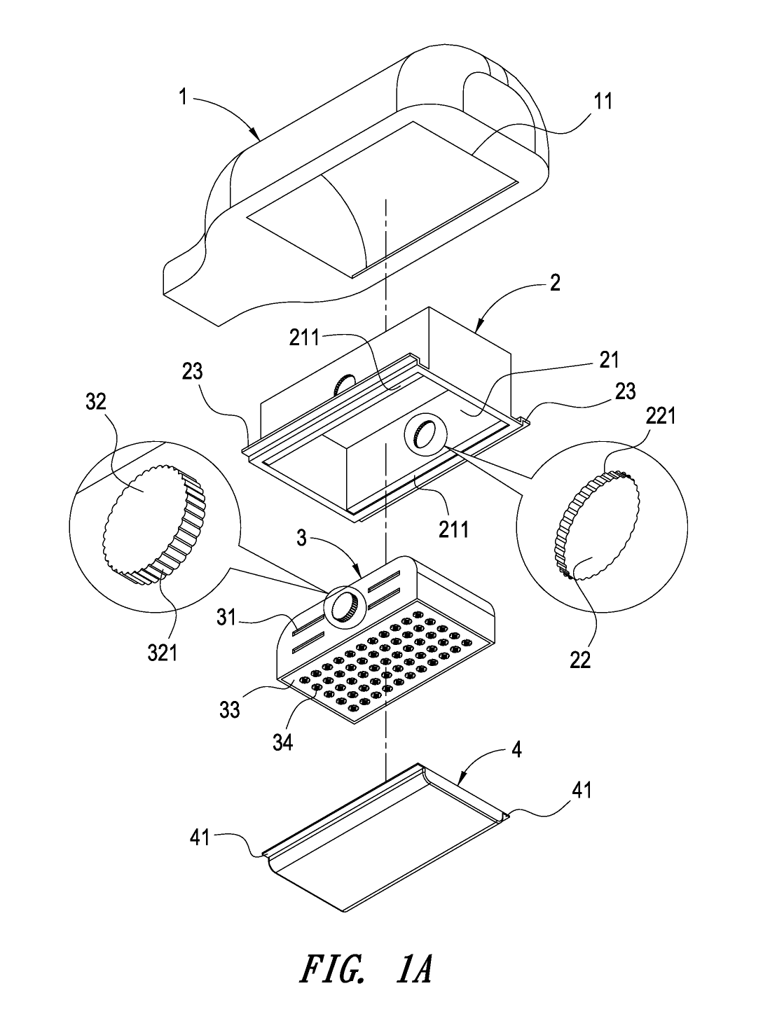

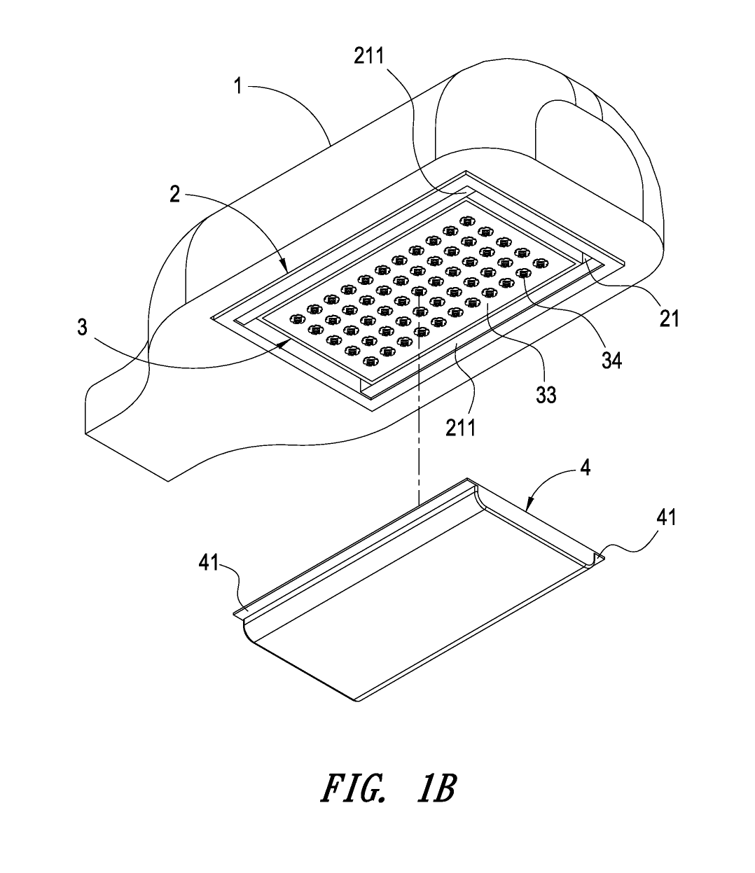

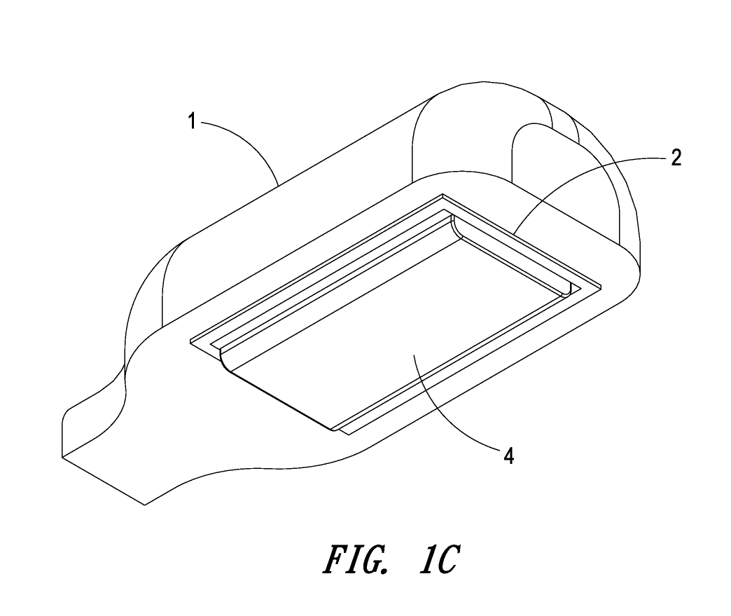

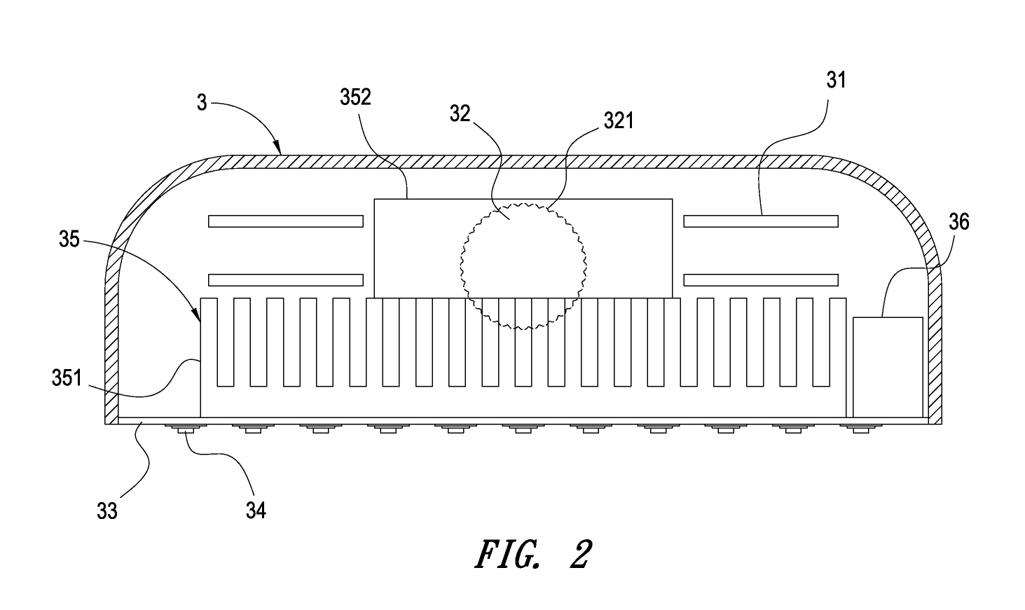

Please see FIGS. 1A, 1B, 1C and 2, which are several views of the outdoor light unit of the present invention. The outdoor light unit of the present invention comprises a casing 1, a seat potion 2, a light portion 3 and a cover portion 4.

A hollow space 11 is provided in the casing 1. A hollow space 21 is provided in the seat potion 2. An engagement slot 211 is provided on the either side of the hollow space 21. A through hole 22 is provided on either wall of the seat potion 2. One or more dented parts 221 are circularly provided on either through hole 22. A protrusion part 23 is provided on either side of the lower portion of the seat potion 2. The seat potion 2 is fitted in the hollow space 11 of the casing 1 by pressing against the two protrusion parts 23.

More than one heat dissipating hole 31 is provided in the light portion 3. A rotation shaft 32 is provided on either side wall of the light portion 3. Either rotation shaft 32 may be aligned with the corresponding through hole 22 of the seat potion 2. At least one protrusion 321 is circularly disposed on either rotation shaft 32. A plate 33 is provided at the lower portion of the light portion 3. One or more light emitting units 34 are fitted to the underside of the plate 33. A heat dissipating module 35 is disposed inside the light portion 3 and above the plate 33. A power supply unit 36 is disposed at an appropriate location inside the light portion 3 to provide electricity to the light emitting units 34. The light portion 3 is fitted in the hollow space 21 of the seat potion 2 with the two rotation shafts 32 engaging with the two through holes 22 of the seat potion 2. The heat dissipating module 35 may consist of a fin-shaped heat dissipating part 351 and a fan 352. The light emitting units 34 may be LEDs or OLEDs.

A protrusion part 41 extends out of either side of the cover portion 4. The two protrusion parts 41 may be aligned and engage with the two engagement slots 211 of the seat potion 2 as the cover portion 4 is fitted to the seat potion 2.

The outdoor light unit of the present invention is formed with the above components.

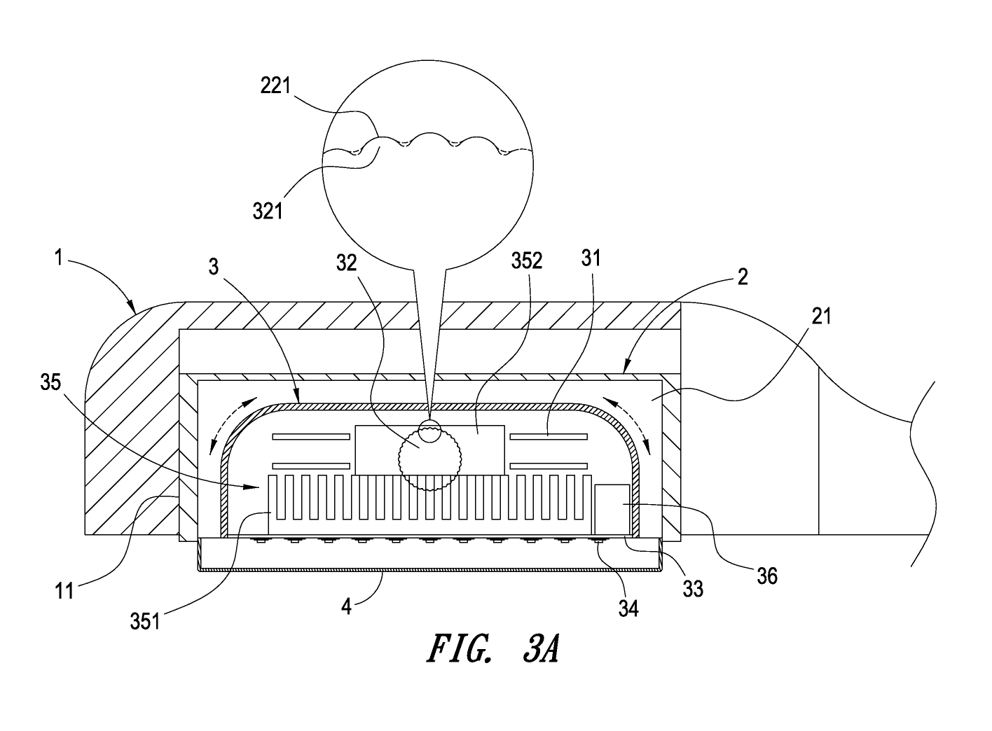

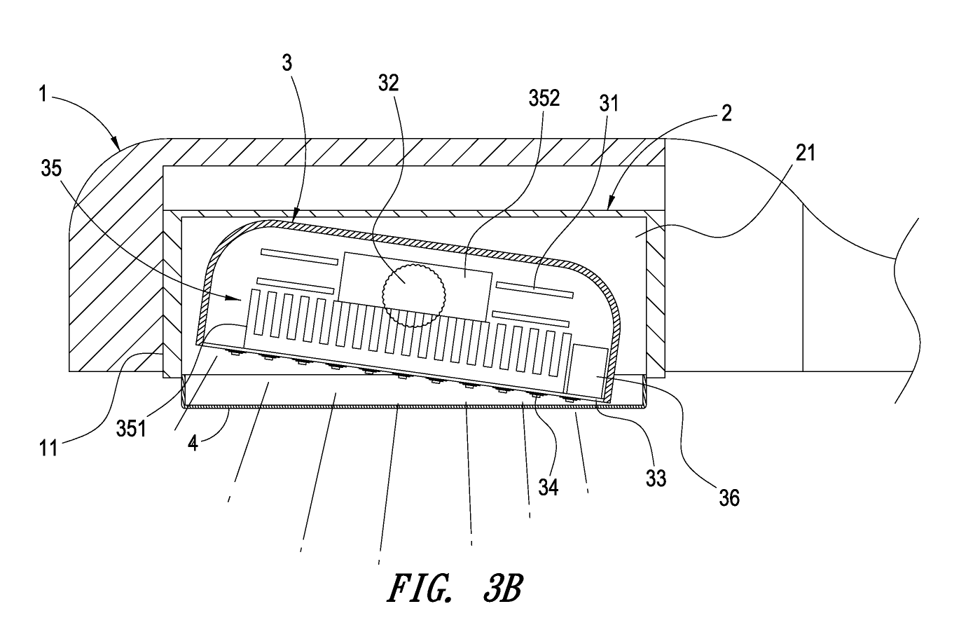

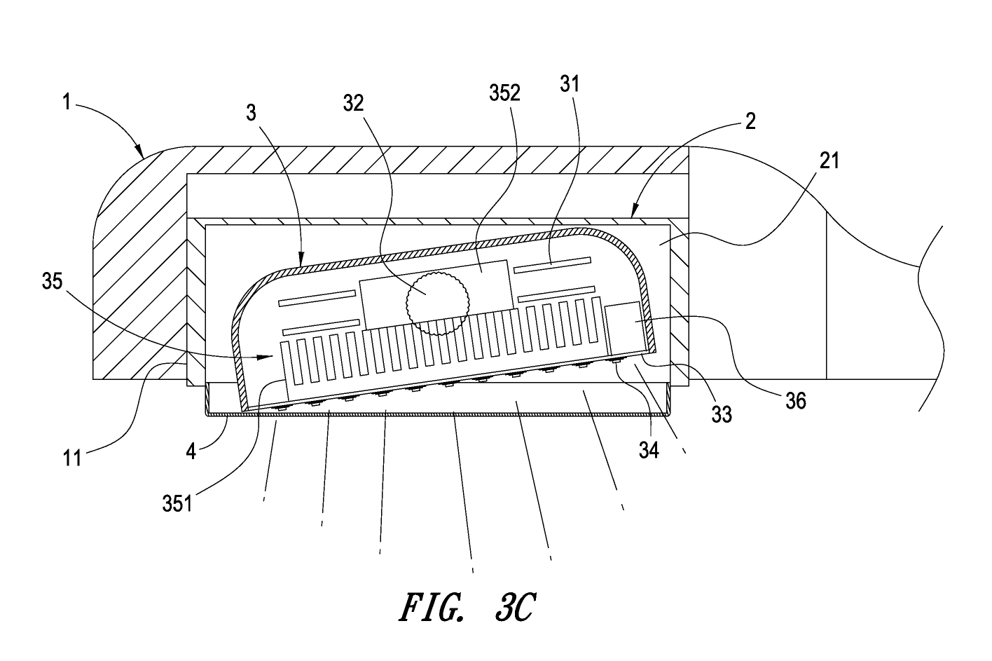

Please see FIGS. 3A, 3B and 3C, which illustrate how the outdoor light unit of the present invention is put together and used. The two rotation shafts 32 engage with the two through holes 22 of the seat potion 2 and dented parts 241 of the two through holes 22 engage with the protrusions 321 of the two rotation shafts 32. Therefore, the angle of the seat potion 2 and light portion 3 may be adjusted. Also, the heat dissipating module 35 may quickly dissipate the heat generated by the light emitting units 34 of the light portion 3 to avoid overheating.

In addition, the two rotation shafts 32 may switch their positions with the two through holes 22 of the seat potion 2 and the function of angle adjustability may still be maintained.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

In comparison to the prior art, the outdoor light unit of the present invention has the following advantages:

1. The outdoor light unit of the present invention can provide an outdoor light unit whose angle may be adjusted according to the actual need.

2. The outdoor light unit of the present invention can provide an outdoor light unit that is structurally simple, easy to use and sturdy and has a low production cost.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

From the above, we can see that the outdoor light unit of the present invention meets the relevant patent requirements. It is hoped that the patent application will be approved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An outdoor light unit with angle adjustability, comprising:
a casing, wherein a hollow space is provided in the casing;
a seat potion, wherein a hollow space is provided in the seat potion and an engagement slot is provided on the either side of the hollow space, and wherein a protrusion part is provided on either side of the lower portion of the seat potion and the seat potion is fitted in the hollow space of the casing with the two protrusion parts pressing against the casing; and
a light portion, wherein more than one heat dissipating hole is provided in the light portion, and wherein a rotation shaft is provided on either side wall of the light portion and either rotation shaft may be aligned with the corresponding through hole of the seat potion, and wherein a plate is provided at the lower portion of the light portion and one or more light emitting units are fitted to the underside of the plate, and wherein the light portion is fitted in the hollow space of the seat potion with the two rotation shafts engaging with the two through holes of the seat potion.

2. The outdoor light unit as in claim 1, wherein a heat dissipating module is disposed inside the light portion and above the plate to lower the temperature of the light emitting units.

3. The outdoor light unit as in claim 2, wherein the heat dissipating module may consist of a fin-shaped heat dissipating part and a fan.

4. The outdoor light unit as in claim 1, wherein a power supply unit is disposed at an appropriate location inside the light portion to provide electricity to the light emitting units.

5. The outdoor light unit as in claim 1, wherein a cover portion may be fitted to the underside of the seat potion to hold the light portion in the outdoor light unit.

6. An outdoor light unit with angle adjustability, comprising:
a casing, wherein a hollow space is provided in the casing;
a seat potion, wherein a hollow space is provided in the seat potion and an engagement slot is provided on the either side of the hollow space, and wherein a through hole is provided on either wall of the seat potion and one or more dented parts are provided on the two through holes, and wherein a protrusion part is provided on either side of the lower portion of the seat potion and the seat potion is fitted in the hollow space of the casing with the two protrusion parts pressing against the casing; and
a light portion, wherein more than one heat dissipating hole is provided in the light portion, and wherein a rotation shaft is provided on either side wall of the light portion and either rotation shaft may be aligned with the corresponding through hole of the seat potion, and wherein one or more protrusions are circularly provided on the two rotation shafts, and wherein a plate is provided at the lower portion of the light portion and one or more light emitting units are fitted to the underside of the plate, and wherein a heat dissipating module is disposed inside the light portion and above the plate and the light portion is fitted in the hollow space of the seat potion with the two rotation shafts engaging with the two through holes of the seat potion.

7. The outdoor light unit as in claim 6, wherein the heat dissipating module may consist of a fin-shaped heat dissipating part and a fan.

8. The outdoor light unit as in claim 6, wherein a power supply unit may be disposed at an appropriate location inside the light portion to provide electricity to the light emitting units.

9. The outdoor light unit as in claim 6, wherein a cover portion may be fitted to the underside of the seat potion to hold the light portion in the outdoor light unit.
